(19) United States
(12) Patent Application Publication
(10) Pub. No.: US 2011/0059337 A1
(43) Pub. Date: Mar. 10, 2011

(54) PROTECTION CIRCUIT FOR SECONDARY BATTERY, BATTERY PACK, AND ELECTRONIC DEVICE

(75) Inventor: Hideharu YOSHIDA, Tokyo (JP)

(73) Assignee: RICOH COMPANY, LTD., Tokyo (JP)

(21) Appl. No.: 12/849,247

(22) Filed: Aug. 3, 2010

(30) Foreign Application Priority Data
Sep. 9, 2009 (JP) 2009-208384

(51) Int. Cl. H01M 10/48; G08B 17/00

(52) U.S. Cl. 429/7; 340/584

(57) ABSTRACT

A protection circuit for protecting a secondary battery includes a temperature detector unit detecting a secondary battery temperature to output a detected signal indicating the detected temperature, an overcharge alarm determination unit determining whether the temperature is equal to or above an upper limit of a standard-temperature range based on the detected signal, and subsequently selecting a first overcharge alarm voltage when the temperature is below the upper limit thereof, or a second overcharge alarm voltage when the temperature is equal to or above the upper limit thereof to output a signal indicating whether a secondary battery voltage is equal to or above the selected one of the first and second overcharge alarm voltages, and an alarm signal generator unit generating, when the secondary battery voltage is equal to or above the selected one of the first and second overcharge alarm voltages, an alarm signal based on the output signal.

### BACKGROUND OF THE INVENTION

1. Field of the Invention

The invention generally relates to a protection circuit for protecting a secondary battery such as a lithium-ion secondary battery against overcharge, a battery pack including such a secondary battery, and an electronic device including the battery pack. Specifically, the invention relates to a protection circuit for protecting a secondary battery based on the voltage and the temperature of the secondary battery, a battery pack including such a secondary battery, and an electronic device including the battery pack.

2. Description of the Related Art

Lithium-ion secondary batteries are frequently used in handheld electronic devices. The lithium-ion secondary batteries may cause accidents due to lithium metal deposition when they are overcharged, or an operating cycle of these batteries may be decreased when they are overdischarged. Accordingly, in a typical electronic device having a secondary battery, a protection switch is provided between the secondary battery and a main body of the electronic device to control the overcharge and overdischarge of the secondary battery in order to avoid such accidents or the decrease in the operating cycle of these batteries. For example, Japanese Patent Publication No. 3498736 discloses a technology to provide a protection switch between a secondary battery and a main body of the electronic device to control the overcharge and overdischarge of the secondary battery such that the protection switch is turned off when the voltage of the secondary battery is equal to or higher than a predetermined overcharge voltage or when the voltage is equal to or lower than a predetermined overdischarge voltage.

Further, Japanese Patent Application Publication No. 2009-44824 discloses a battery pack that exhibits similar effects. The disclosed battery pack includes a protection circuit for protecting a secondary battery to detect an overcharge, an overdischarge, and a charge overcurrent of the secondary battery to control the turning on or off of the first and second switching devices provided in the line between a secondary battery and a load or a battery charger, thereby protecting the secondary battery. The disclosed battery pack further includes a series circuit including a thermistor connected in parallel to the secondary battery located closed to the thermistor and a resistor, a comparator comparing the reference voltage to a predetermined temperature at a node between the thermistor and the resistor in the protection circuit, and a third switching device connected between the resistor and a cathode of the secondary battery, where the protection circuit turns off the first and third switching devices when the overdischarge of the secondary battery is detected. With this technology, the temperature of the secondary battery may be accurately controlled.

However, with the ignition accidents of recent secondary batteries, there has been an increasing need for formulating and implementing guidelines concerning safer use of lithium-ion secondary battery.

### SUMMARY OF THE INVENTION

Accordingly, it may be desirable to provide a protection circuit for protecting a secondary battery with which the battery is capable of being handled safer than the related art technologies, a battery pack having the protection circuit, and an electronic device having the battery pack, solving one or more problems discussed above.

In one embodiment, there is provided a protection circuit for protecting a secondary battery that includes a temperature detector unit configured to detect a temperature of the secondary battery and to output a detected signal indicating the detected temperature; an overcharge alarm determination unit configured to determine whether or not the detected temperature is equal to or higher than an upper limit of a standard-temperature range based on the detected signal, and to subsequently select a predetermined first overcharge alarm voltage when the detected temperature is lower than the upper limit of the standard-temperature range, or to subsequently select a predetermined second overcharge alarm voltage that is lower than the predetermined first overcharge alarm voltage when the detected temperature is equal to or higher than the upper limit of the standard-temperature range, so as to output a signal indicating whether or not a voltage of the secondary battery is equal to or higher than the selected one of the first overcharge alarm voltage and the second overcharge alarm voltage; and an alarm signal generator unit configured to generate, when the voltage of the secondary battery is equal to or higher than the selected one of the first overcharge alarm voltage and the second overcharge alarm voltage, an alarm signal based on the signal output from the overcharge alarm determination unit.

According to another embodiment, there is provided a battery pack that includes a secondary battery and the above protection circuit.

According to another embodiment, there is provided an electronic devices that includes the above battery pack.

### BRIEF DESCRIPTION OF THE DRAWINGS

Other objects and further features of embodiments will be apparent from the following detailed description when read in conjunction with the accompanying drawings, in which:

FIG. 1 is a block diagram illustrating an example of a battery pack 1 according to a first embodiment;

FIG. 2 is a circuit diagram of a charge-discharge protection circuit 10 illustrated in FIG. 1;

FIG. 3 is a graph illustrating temperature ranges A1, A2 and A3 in which a low-level alarm signal Sa, a pulsed signal Sa and a high-level alarm signal are respectively generated from the charge-discharge protection circuit 10 illustrated in FIG. 2; and

FIG. 4 is a circuit diagram of a charge-discharge protection circuit 10A according to a second embodiment.

### DESCRIPTION OF THE PREFERRED EMBODIMENTS

Preferred embodiments are described below with reference to the accompanying drawings. Note that same reference numerals are assigned to similar components in the following embodiments.

### First Embodiment

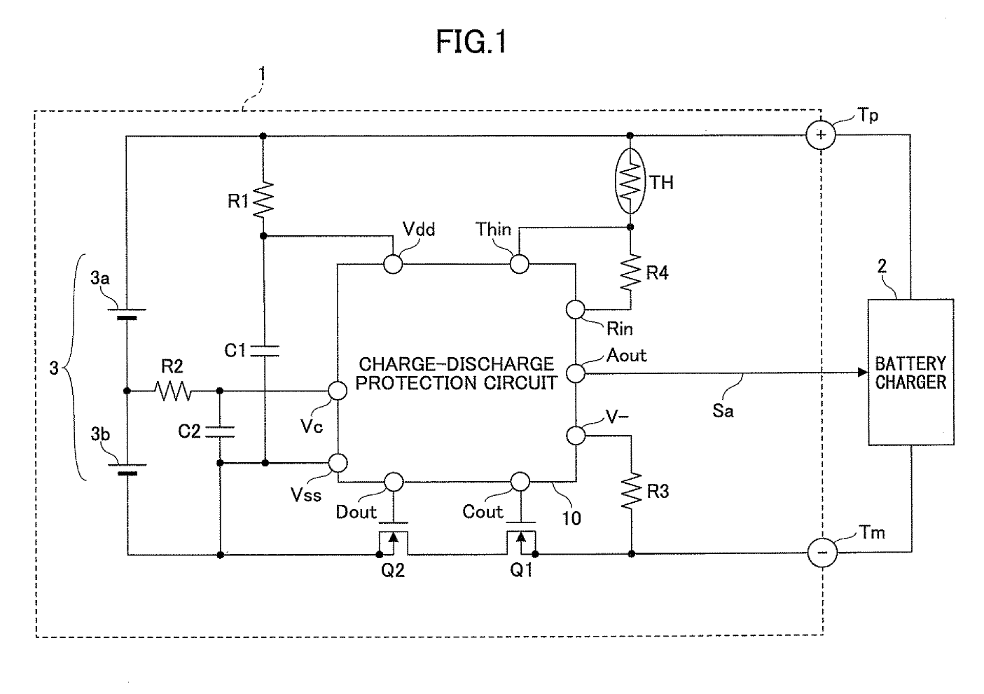

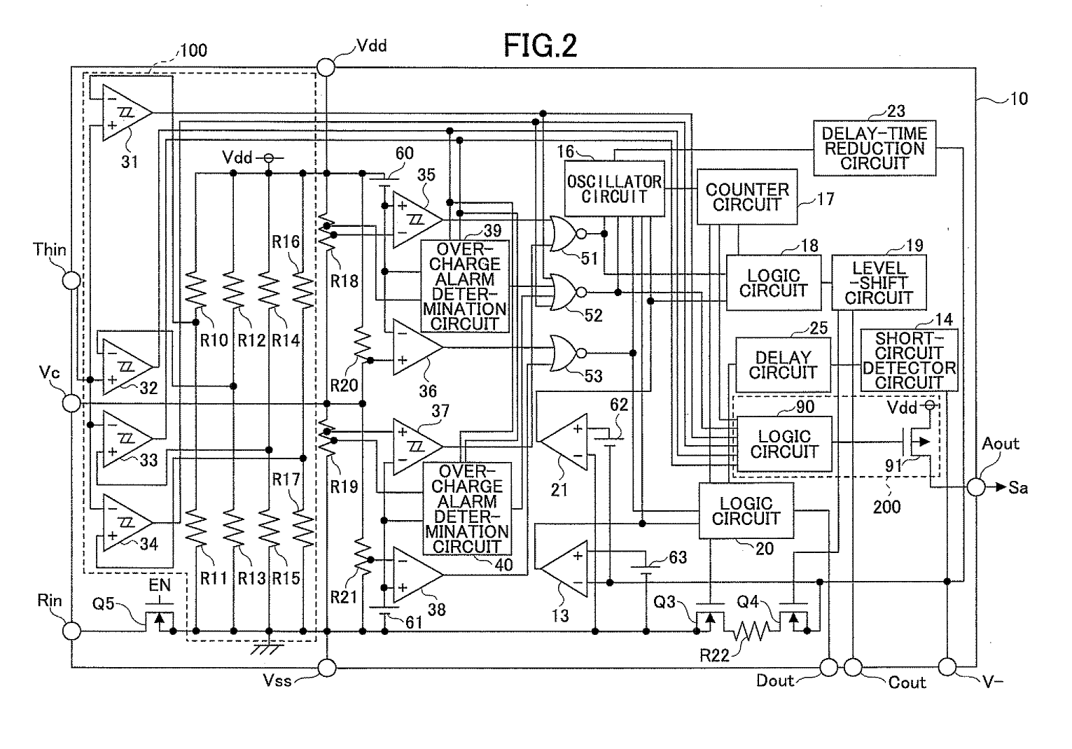

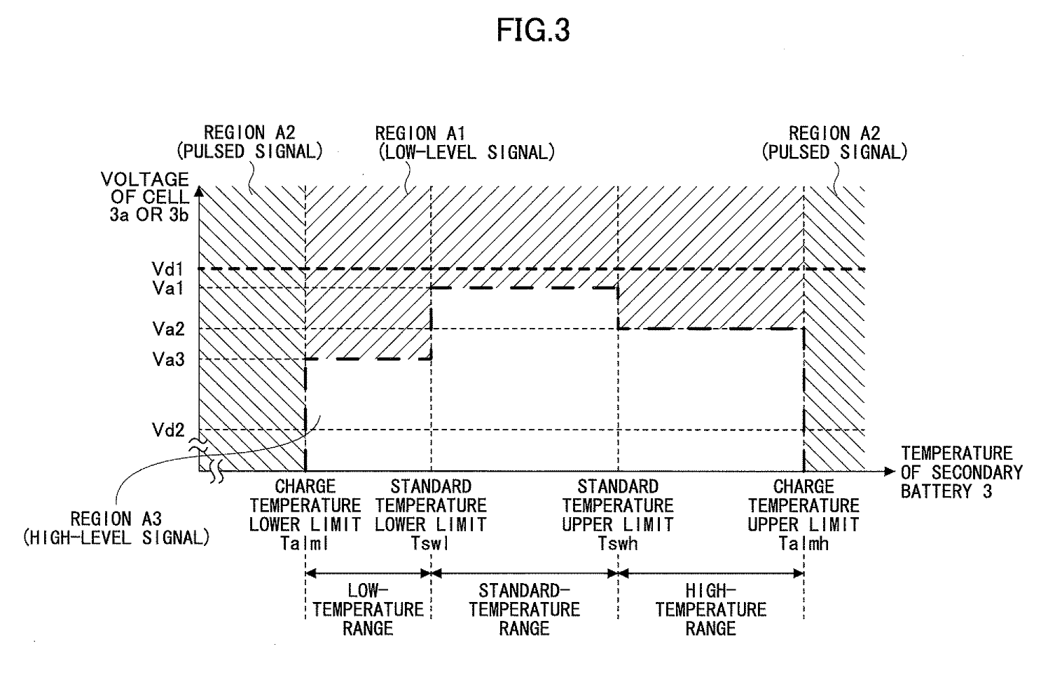

FIG. 1 is a block diagram illustrating an example of a battery pack 1 according to a first embodiment, and FIG. 2 is a circuit diagram of a charge-discharge protection circuit 10 illustrated in FIG. 1. FIG. 3 is a graph illustrating a temperature range A1 in which a low-level alarm signal Sa is output from the charge-discharge protection circuit 10 illustrated in FIG. 2, a temperature range A2 in which a pulse type signal (alarm signal of a pulse type) Sa is output from the charge-discharge protection circuit 10, and a temperature range A3 in which a high-level alarm signal Sa is output from the charge-discharge protection circuit 10.

The battery pack 1 illustrated in FIG. 1 is generally incorporated in handheld electronic devices such as digital still cameras. Referring to FIG. 1, the battery pack 1 includes a secondary battery 3 having serially connected first and second lithium-ion secondary battery cells 3a and 3b (hereinafter simply referred to as the “cells 3a and 3b”), a charge-discharge protection circuit 10, a charge control FET composed of an N-channel MOS field-effect transistor Q1, a discharge control FET composed of an N-channel MOS field-effect transistor Q2, resistors R1 through R4, capacitors C1 and C2, and a thermistor TH. In the battery pack 1 in FIG. 1, a negative terminal of the first cell 3a and a positive terminal of the second cell 3b are mutually connected. Further, a positive terminal of the first cell 3a is connected to a terminal Tp of the battery pack 1, and a negative terminal of the second cell 3b is connected to a terminal Tm of the battery pack 1 via the charge control FET Q1 and the discharge control FET Q2.

A drain of the charge control FET Q1 is connected to a drain of the discharge control FET Q2. A source of the charge control FET Q1 is connected to the terminal Tm of the battery pack 1 whereas a source of the discharge control FET Q2 is connected to the negative terminal of the second cell 3b. A gate of the charge control FET Q1 is connected to a terminal Cout of the charge-discharge protection circuit 10 whereas a gate of the discharge control FET Q2 is connected to a terminal Dout of the charge-discharge protection circuit 10.

Further, the thermistor TH is a negative temperature coefficient (NTC) thermistor, which is arranged close to the secondary battery 3 and is thermally connected to the secondary battery 3 in the battery pack 1. The thermistor TH is thus configured to detect a surface temperature of the secondary battery 3. A first end of the thermistor TH is connected to the positive terminal of the first cell 3a and a second end of the thermistor TH is connected to a terminal Thin of the charge-discharge protection circuit 10. The second end of the thermistor TH is also connected to a terminal Rin of the charge-discharge protection circuit 10 via the resistor R4 that operates as a reference resistor. With the this configuration, the charge-discharge protection circuit 10 outputs a signal having a higher voltage level with an increase in the surface temperature of the secondary battery 3.

A series circuit composed of the resistor R1 and the capacitor C1 is connected between the positive terminal of the first cell 3a and the negative terminal of the second cell 3b, and a node between the resistor R1 and the capacitor C1 is connected to a terminal Vdd of the charge-discharge protection circuit 10. In addition, a series circuit composed of the resistor R2 and the capacitor C2 is connected between the positive terminal of the second cell 3b and the negative terminal of the second cell 3b, and anode between the resistor R2 and the capacitor C2 is connected to a terminal Vc of the charge-discharge protection circuit 10. The negative terminal of the second cell 3b is connected to a terminal Vss of the charge-discharge protection circuit 10.

Further, the resistor R3 is connected between the terminal Tm of the battery pack 1 and a terminal V− of the charge-discharge protection circuit 10. An alarm signal Sa generated from the charge-discharge protection circuit 10 is output to a battery charger 2 via a terminal Aout of the charge-discharge protection circuit 10. For charging the secondary battery 3, the battery charger 2 is connected between the terminals Tp and Tm of the battery pack 1, and carries out predetermined operations based on the alarm signal Sa generated from the charge-discharge protection circuit 10.

As illustrated in FIG. 2, the charge-discharge protection circuit 10 includes a temperature detector circuit 100 having comparators 31 through 34 and resistors R10 through R17, comparators 13, 21, and 35 through 38, overcharge alarm determination circuits 39 and 40, resistors R18 through R22, N-channel MOS field-effect transistors Q3 through Q5, direct-current (DC) voltage sources 60 through 63, NOR gates 51 through 53, an oscillator circuit 16, a counter circuit 17, logic circuits 18 and 20, a short-circuit detector circuit 14, a level-shift circuit 19, a delay-time reduction circuit 23, a delay circuit 25, and an alarm signal generator circuit 200 having a logic circuit 90 and a P-channel MOS field-effect transistor 91.

In the first embodiment, the temperature ranges for the secondary battery 3 includes a low-temperature range, a standard-temperature range, and a high-temperature range as illustrated in FIG. 3. In FIG. 3, a charge temperature lower limit “Talml” represents a lower limit of the low-temperature range, a standard temperature lower limit “Tswl” and a standard temperature upper limit “Tswh” respectively represent a lower limit and an upper limit of the standard-temperature range, and a charge temperature upper limit “Talmh” represents an upper limit of the high-temperature range for charging the secondary battery 3.

As illustrated in FIG. 2, the temperature detector circuit 100 is configured to detect whether the surface temperature of the secondary battery 3 is: (a) equal to or lower than the charge temperature lower limit Talml, (b) within the low-temperature range, (c) within the standard-temperature range, within the high-temperature range, or (d) equal to or higher than the charge temperature upper limit Talmh. Specifically, a non-inverting input terminal of the comparator 31 having hysteresis characteristics is connected to the terminal Thin, an inverting input terminal of the comparator 31 is connected to a node of the serially connected resistors R10 and R11 connected between the terminals Vss and Vdd, and an output terminal of the comparator 31 is connected to a first input terminal of the NOR gate 52. Specifically, a non-inverting input terminal of the comparator 32 having hysteresis characteristics is connected to the terminal Thin, an inverting input terminal of the comparator 32 is connected to a node of the serially connected resistors R12 and R13 connected between the terminals Vss and Vdd, and an output terminal of the comparator 32 is connected to the logic circuit 90 and also to overcharge alarm determination circuits 39 and 40. Further, an inverting input terminal of the comparator 33 having hysteresis characteristics is connected to the terminal Thin, a non-inverting input terminal of the comparator 33 is connected to a node of the serially connected resistors R14 and R15 connected between the terminals Vss and Vdd, and an output terminal of the comparator 33 is connected to the logic circuit 90 and also to overcharge alarm determination circuits 39 and 40. Moreover, an inverting input terminal of the comparator 34 having hysteresis characteristics is connected to the terminal Thin, an inverting input terminal of the comparator 34 is connected to a node of the serially connected resistors R16 and R17 connected between the terminals Vss and Vdd, and an output terminal of the comparator 34 is connected to the logic circuit 90 and also to a second input terminal of the NOR gate 52.

In the first embodiment, the respective resistance values for the resistors R10 and R11 illustrated in FIG. 2 are set such that the reference voltage corresponding to the charge temperature upper limit Talmh of the secondary battery 3 is output to the inverting input terminal of the comparator 31, and the respective resistance values for the resistors R12 and R13 are set such that the reference voltage corresponding to the standard temperature upper limit Tswh of the secondary battery 3 is output to the inverting input terminal of the comparator 32. Further, the respective resistance values for the resistors R14 and R15 are set such that the reference voltage corresponding to the standard temperature lower limit Tswl of the secondary battery 3 is output to the non-inverting input terminal of the comparator 33, and the respective resistance values for the resistors R16 and R17 are set such that the reference voltage corresponding to the charge temperature lower limit Talml of the secondary battery 3 is output to the non-inverting input terminal of the comparator 34.

A comparator 35 having hysteresis characteristics is configured to determine whether the voltage of the cell 3a is equal to or higher than a predetermined overcharge detection voltage Vd1 (see FIG. 3). When the cell 3a has a voltage equal to or higher than the predetermined overcharge detection voltage Vd1, the comparator 35 outputs a high-level signal to a first input terminal of the NOR gate 51; whereas when the cell 3a has a voltage lower than the predetermined overcharge detection voltage Vd1, the comparator 35 outputs a low-level signal to the first input terminal of the NOR gate 51. More specifically, a non-inverting input terminal of the comparator 35 is connected via a direct-current voltage source 60 to the terminal Vdd, and an inverting input terminal of the comparator 35 is connected to a predetermined voltage divider node of the voltage divider resistor R18 connected between the terminals Vdd and Vc. Note that the voltage divider node of the resistor R18 is set such that a corresponding reference voltage of the predetermined overcharge detection voltage Vd1 is output to the inverting input terminal of the comparator 35. An output terminal of the comparator 35 is connected to the first input terminal of the NOR gate 51.

Further, in FIG. 2, a comparator 36 having hysteresis characteristics is configured to determine whether the voltage of the cell 3a is equal to or lower than a predetermined overdischarge detection voltage Vd2. When the cell 3a has a voltage equal to or lower than the predetermined overdischarge detection voltage Vd2, the comparator 36 outputs a high-level signal to the first input terminal of the NOR gate 53; whereas when the cell 3a has a voltage higher than the predetermined overdischarge detection voltage Vd2, the comparator 36 outputs a low-level signal to the first input terminal of the NOR gate 53. More specifically, the inverting input terminal of the comparator 36 is connected via the direct-current voltage source 60 to the terminal Vdd, and the non-inverting input terminal of the comparator 36 is connected to a predetermined voltage divider node of the voltage divider resistor R20 connected between the terminals Vdd and Vc. Note that the voltage divider node of the resistor R20 is set such that a corresponding reference voltage of the predetermined overdischarge detection voltage Vd2 is output to the non-inverting input terminal of the comparator 36. An output terminal of the comparator 36 is connected to the first input terminal of the NOR gate 53.

A comparator 37 having hysteresis characteristics is configured to determine whether the voltage of the cell 3b is equal to or higher than a predetermined overcharge detection voltage Vd1 (see FIG. 3). When the cell 3b has a voltage equal to or higher than the predetermined overcharge detection voltage Vd1, the comparator 37 outputs a high-level signal to a second input terminal of the NOR gate 51; whereas when the cell 3b has a voltage lower than the predetermined overcharge detection voltage Vd1, the comparator 37 outputs a low-level signal to the second input terminal of the NOR gate 51. More specifically, the inverting input terminal of the comparator 37 is connected via a direct-current voltage source 61 to the terminal Vss, and the non-inverting input terminal of the comparator 37 is connected to a predetermined voltage divider node of the voltage divider resistor R19 connected between the terminals Vss and Vc. Note that the voltage divider node of the resistor R19 is set such that a corresponding reference voltage of the predetermined overcharge detection voltage Vd1 is output to the inverting input terminal of the comparator 37. An output terminal of the comparator 37 is connected to the second input terminal of the NOR gate 51.

Further, a comparator 38 having hysteresis characteristics is configured to determine whether the voltage of the cell 3b is equal to or lower than a predetermined overdischarge detection voltage Vd2 (see FIG. 3). When the cell 3b has a voltage equal to or lower than the predetermined overdischarge detection voltage Vd2, the comparator 38 outputs a high-level signal to the second input terminal of the NOR gate 53; whereas when the cell 3b has a voltage higher than the predetermined overdischarge detection voltage Vd2, the comparator 38 outputs a low-level signal to the second input terminal of the NOR gate 53. More specifically, the non-inverting input terminal of the comparator 38 is connected via the direct-current voltage source 61 to the terminal Vss, and the inverting input terminal of the comparator 38 is connected to a predetermined voltage divider node of the voltage divider resistor R21 connected between the terminals Vss and Vc. Note that the voltage divider node of the voltage divider resistor R21 is set such that a corresponding reference voltage of the predetermined overdischarge detection voltage Vd2 is output to the inverting input terminal of the comparator 38. An output terminal of the comparator 38 is connected to the second input terminal of the NOR gate 53.

As illustrated in FIG. 2, the overcharge alarm determination circuit 39 is configured to select one of predetermined overcharge alarm voltages Va1, Va2 and Va3 (see FIG. 3) based on corresponding signals output from the comparators 32 and 33. When the cell 3a has a voltage equal to or higher than the selected one of the overcharge alarm voltages Va1, Va2 and Va3, the overcharge alarm determination circuit 39 outputs a high-level signal to a third input terminal of the NOR gate 53; whereas when the cell 3a has a voltage lower than the selected one of the overcharge alarm voltages Va1, Va2 and Va3, the overcharge alarm determination circuit 39 outputs a low-level signal to the third input terminal of the NOR gate 53. Note that as illustrated in FIG. 3, the overcharge alarm voltages Va1, Va2 and Va3, and the overcharge detection voltage Vd1 are predetermined such that the condition represented by Va3<Va2<Va2<Vd1 is satisfied. More specifically, in FIG. 2, when the surface temperature of the secondary battery 3 is equal to or lower than the standard temperature lower limit Tswl, the overcharge alarm determination circuit 39 switches the voltage divider node of the voltage divider resistance R18 to output the overcharge alarm voltage Va3. When the surface temperature of the secondary battery 3 is higher than the standard temperature lower limit Tswl and lower than the standard temperature upper limit Tswh, the overcharge alarm determination circuit 39 switches the voltage divider node of the voltage divider resistance R18 to output the overcharge alarm voltage Va1. When the surface temperature of the secondary battery 3 is equal to or higher than the standard temperature upper limit Tswh, the overcharge alarm determination circuit 39 switches the voltage divider node of the voltage divider resistance R18 to output the overcharge alarm voltage Va2.

Likewise, the overcharge alarm determination circuit 40 is configured to select one of predetermined overcharge alarm voltages Va1, Va2 and Va3 (see FIG. 3) based on corresponding signals output from the comparators 32 and 33. When the cell 3b has a voltage equal to or higher than the selected one of the overcharge alarm voltages Va1, Va2 and Va3, the overcharge alarm determination circuit 40 outputs a high-level signal to a fourth input terminal of the NOR gate 52; whereas when the cell 3b has a voltage lower than the selected one of the overcharge alarm voltages Va1, Va2 and Va3, the overcharge alarm determination circuit 40 outputs a low-level signal to the fourth input terminal of the NOR gate 52. More specifically, in FIG. 2, when the surface temperature of the secondary battery 3 is equal to or lower than the standard temperature lower limit Tswl, the overcharge alarm determination circuit 40 switches the voltage divider node of the voltage divider resistance R19 to output the overcharge alarm voltage Va3. When the surface temperature of the secondary battery 3 is higher than the standard temperature lower limit Tswl and lower than the standard temperature upper limit Tswh, the overcharge alarm determination circuit 39 switches the voltage divider node of the voltage divider resistance R19 to output the overcharge alarm voltage Va1. When the surface temperature of the secondary battery 3 is equal to or higher than the standard temperature upper limit Tswh, the overcharge alarm determination circuit 39 switches the voltage divider node of the voltage divider resistance R19 to output the overcharge alarm voltage Va2.

Further, the signal output from the NOR gate 51 is output to the oscillator circuit 16 and the logic circuit 18, the signal output from the NOR gate 52 is output to the oscillator circuit 16 and the logic circuit 90, and the signal output from the NOR gate 53 is output to the oscillator circuit 16 and the logic circuit 20.

As illustrated in FIG. 2, the comparator 21 is configured as a charge overcurrent detector circuit to determine whether a charge current of the secondary battery 3 is equal to or higher than a predetermined first current value. When the charge current of the secondary battery 3 is equal to or higher than the predetermined first current value, the comparator 21 outputs a low-level signal to the oscillator circuit 16 and the logic circuit 18, whereas when the charge current of the secondary battery 3 is lower than the predetermined first current value, the comparator 21 outputs a high-level signal to the oscillator circuit 16 and the logic circuit 18. More specifically, a non-inverting input terminal of the comparator 21 is connected via a direct-current voltage source 62 to the terminal V−, and an inverting input terminal of the comparator 21 is connected to the terminal Vss.

Further, as illustrated in FIG. 2, the comparator 13 is configured to determine whether a discharge current of the secondary battery 3 is equal to or higher than a predetermined second current value. When the discharge current of the secondary battery 3 is equal to or higher than the predetermined second current value, the comparator 13 outputs a low-level signal to the oscillator circuit 16 and the logic circuit 20, whereas when the discharge current of the secondary battery 3 is lower than the predetermined second current value, the comparator 13 outputs a high-level signal to the oscillator circuit 16 and the logic circuit 20. More specifically, a non-inverting input terminal of the comparator 13 is connected via the direct-current voltage source 63 to the terminal Vss, and an inverting input terminal of the comparator 13 is connected to the terminal V−.

The short-circuit detector circuit 14 is configured to detect whether the secondary battery 3 is short-circuited based on the voltage of the terminal V−. When the secondary battery 3 is short-circuited, the short-circuit detector circuit 14 outputs a low-level signal via the delay circuit 25 to the logic circuit 20. When the secondary battery 3 is not short-circuited, the short-circuit detector circuit 14 outputs a high-level signal via the delay circuit 25 to the logic circuit 20.

Respective drains of the N-channel MOS field-effect transistors Q3 and Q4 are connected to each other via the resistor R22, a source of the N-channel MOS field-effect transistor Q3 is connected to the terminal Vss, and a source of the N-channel MOS field-effect transistor Q4 is connected to the terminal V−. A drain of the N-channel MOS field-effect transistor Q5 is connected to the terminal Rin, and a source of the N-channel MOS field-effect transistor Q5 is connected to the terminal Vss. A voltage EN is applied to a gate of the N-channel MOS field-effect transistor Q5. Note that the N-channel MOS field-effect transistor Q5 is turned ON while the secondary battery 3 is being charged.

The oscillator circuit 16 oscillates, when at least one of the voltages corresponding to the signals output from the NOR gates 51 through 53 and the comparators 13 and 23 is a low level, to generate a predetermined clock signal and output the generated clock signal to the counter circuit 17. The counter circuit 17 counts the number of clocks generated from the oscillator circuit 16 and outputs a counted signal corresponding to the counted result to the logic circuits 18, 20, and 90. The delay-time reduction circuit 23 changes the frequency of the clock signal generated by the oscillator 16 based on the voltage of the terminal V−.

The logic circuit 18 configured as a signal generator circuit outputs a high-level control signal via the level-shift circuit 19 to the terminal Cout and also to a gate of the N-channel MOS field-effect transistor Q4 when the voltages of the respective signals output from the NOR gate 51 and the comparator 21 are each a high level. By contrast, the logic circuit 18 outputs a low-level control signal via the level-shift circuit 19 to the terminal Cout and also to the gate of the N-channel MOS field-effect transistor Q4 when the voltages of the respective signals output from the NOR gate 51 and the comparator 21 are each a low level. Accordingly, when at least one of the voltages of the cells 3a and 3b is equal to or higher than the overcharge detection voltage Vd1, and/or at least one of the charge currents for the cells 3a and 3b is equal to or higher than the predetermined first current value, the logic circuit 18 generates a low-level control signal for controlling cutting off of a charging path of the secondary battery 3 and outputs the generated low-level control signal to the terminal Cout.

The logic circuit 20 configured as a signal generator circuit outputs a high-level control signal to the terminal Dout and also to a gate of the N-channel MOS field-effect transistor Q3 when the voltages of the respective signals output from the NOR gate 53 and the comparator 13 are each a high level. By contrast, the logic circuit 18 outputs a low-level control signal to the terminal Dout and also to the gate of the N-channel MOS field-effect transistor Q3 when the voltages of the respective signals output from the NOR gate 53 and the comparator 13 are each a low level. Accordingly, when at least one of the voltages of the cells 3a and 3b is equal to or lower than the overdischarge detection voltage Vd2, and/or at least one of the discharge currents for the cells 3a and 3b is equal to or higher than the predetermined second current value, the logic circuit 20 generates a low-level control signal for controlling cutting off of a discharging path of the secondary battery 3 and outputs the generated low-level control signal to the terminal Dout.

In the alarm signal generator circuit 200, a drain of the P-channel MOS field-effect transistor 91 is connected to the terminal Aout, and a source of the P-channel MOS field-effect transistor 91 is connected to the terminal Vdd. The logic circuit 90 outputs a low-level signal to a gate of the P-channel MOS field-effect transistor 91 when receiving a high-level signal output from the NOR gate 52. Accordingly, a high-level alarm signal Sa is output from the terminal Aout. Further, when receiving a low-level signal output from the NOR gate 52, the logic circuit 90 determines, based on the respective signals output from the comparators 31 through 34, (a) whether the surface temperature of the secondary battery 3 is equal to or lower than the charge temperature lower limit Talml, or whether the surface temperature of the secondary battery 3 is equal to higher than the charge temperature upper limit Talmh; or (b) whether the surface temperature of the secondary battery 3 is higher than the charge temperature lower limit Talml and lower than the charge temperature upper limit Talmh. When the surface temperature of the secondary battery 3 is equal to or lower than the charge temperature lower limit Talml or when the surface temperature of the secondary battery 3 is equal to or higher than the charge temperature upper limit Talmh, the logic circuit 90 generates a pulse signal to output the generated pulse signal to the gate of the P-channel MOS field-effect transistor 91. Accordingly, a pulsed signal Sa is output from the terminal Aout. When the surface temperature of the secondary battery 3 is higher than the charge temperature lower limit Talml and lower than the charge temperature upper limit Talmh, the logic circuit 90 generates a high-level signal to output the generated high-level signal to the gate of the P-channel MOS field-effect transistor 91. Accordingly, a low-level signal alarm signal Sa is output from the terminal Aout.

Next, Operations of the charge-discharge protection circuit 10 configured as described above are described below.

When the charge-discharge protection circuit 10 is in a condition where the respective voltages of the cells 3a and 3b are higher than the overdischarge detection voltage Vd2, and the surface temperature of the secondary battery 3 and the voltage of the cell 3a and the surface temperature of the secondary battery 3 and the voltage of the cell 3b are within the region A3 (i.e., normal state) illustrated in FIG. 3, a high-level signal is output from the terminals Cout and Dout, thereby turning ON the charge control FET Q1 and the discharge control FET Q2. In this state, the secondary battery 3 may be charged or discharged. Further, a high-level alarm signal Sa is output from the terminal Aout, and the battery charger 2 determines that the battery pack is in a normal state in response to the output high-level alarm signal Sa received from the terminal Aout.

Moreover, when the surface temperature of the secondary battery 3 is within the standard-temperature range, and at least one of the voltages of the cells 3a and 3b is equal to or higher than the overcharge detection voltage Vd1, a high-level signal is output from the terminal Dout and a low-level signal is output from the terminal Cout. In response to the high-level signal output from the terminal Dout and the low-level signal output from the terminal Cout, the charge control FET Q1 is turned ON so that the battery charger 2 stops charging the secondary battery 3. Further, a low-level alarm signal Sa is output from the terminal Aout, and the battery charger 2 stops charging the secondary battery 3 in response to the low-level alarm signal Sa output from the terminal Aout.

Moreover, when the surface temperature of the secondary battery 3 is within the standard-temperature range (see FIG. 3), and at least one of the voltages of the cells 3a and 3b is equal to or lower than the overdischarge detection voltage Vd2, a high-level signal is output from the terminal Cout and a low-level signal is output from the terminal Dout. In response to the high-level signal output from the terminal Cout and the low-level signal output from the terminal Dout, the discharge control FET Q2 is turned OFF so that the battery charger 2 stops discharging the secondary battery 3. Further, a high-level alarm signal Sa is output from the terminal Aout, and the battery charger 2 does not control charging or discharging of the secondary battery 3.

Still further, when the surface temperature of the secondary battery 3 is within the standard-temperature range (see FIG. 3), and a discharge overcurrent is detected, a high-level signal is output from the terminal Cout and a low-level signal is output from the terminal Dout. In response to the high-level signal output from the terminal Cout and the low-level signal output from the terminal Dout, the discharge control FET Q2 is turned OFF so that the battery charger 2 stops discharging the secondary battery 3. Further, a high-level alarm signal Sa is output from the terminal Aout, and the battery charger 2 does not control charging or discharging of the secondary battery 3.

Still further, when the surface temperature of the secondary battery 3 is within the standard-temperature range (see FIG. 3), and a charge overcurrent is detected, a low-level signal is output from the terminal Cout and a high-level signal is output from the terminal Dout. In response to the low-level signal output from the terminal Cout and the high-level signal output from the terminal Dout, the charge control FET Q1 is turned OFF so that the battery charger 2 stops discharging the secondary battery 3. Further, a high-level alarm signal Sa is output from the terminal Aout, and the battery charger 2 does not control charging or discharging of the secondary battery 3.

Moreover, when the surface temperature of the secondary battery 3 is equal to or higher than the charge temperature upper limit Talmh, and the voltages of the cells 3a and 3b are both higher than the overdischarge detection voltage Vd2 and lower than the overcharge detection voltage Vd1, a high-level signal is output from the terminals Cout and Dout. In response to the high-level signals output from the terminals Cout and Dout, the charge control FET Q1 and the discharge control FET Q2 are turned ON to charge or discharge the secondary battery 3. Further, a pulsed signal Sa is output from the terminal Aout, and in response to the output pulsed signal Sa, the battery charger 2 detects an abnormal temperature of the secondary battery 3 to thereby stop charging the secondary battery 3.

Moreover, when the surface temperature of the secondary battery 3 is equal to or lower than the charge temperature lower limit Talml, and the voltages of the cells 3a and 3b are both higher than the overdischarge detection voltage Vd2 and lower than the overcharge detection voltage Vd1, a high-level signal is output from the terminals Cout and Dout. In response to the high-level signals output from the terminals Cout and Dout, the charge control FET Q1 and the discharge control FET Q2 are turned ON to charge or discharge the secondary battery 3. Further, a pulsed signal Sa is output from the terminal Aout, and in response to the output pulsed signal Sa, the battery charger 2 detects an abnormal temperature of the secondary battery 3 to thereby stop charging the secondary battery 3.

In general, a charging response in the high-temperature range is less safe due to instability in the crystal structure of the cathode of the secondary battery 3. Further, since a mass transfer rate is decreased in the charging response in the low-temperature range, and an insertion rate of the lithium ion into the carbon-based anode of the secondary battery 3 becomes slow, lithium may be deposited on the carbon-based anode of the secondary battery 3. Accordingly, in view of safety, the charging of the secondary battery 3 in the high-temperature range or in the low-temperature range is preferably carried out under the more strict condition than the charging of the secondary battery 3 in the standard-temperature range. According to the first embodiment, when the surface temperature of the secondary battery 3 is within the high-temperature range, the voltages of the cells 3a and 3b are each compared with the overcharge alarm voltage Va2 that is lower than the overcharge alarm voltage Va1. When at least one of the voltages of the cells 3a and 3b is equal to or higher than the overcharge alarm voltage Va2, a low-level alarm signal Sa is output from the terminal Aout. Further, when the surface temperature of the secondary battery 3 is within the low-temperature range, the voltages of the cells 3a and 3b are each compared with the overcharge alarm voltage Va3 that is lower than the overcharge alarm voltage Va1. When at least one of the voltages of the cells 3a and 3b is equal to or higher than the overcharge alarm voltage Va3, a low-level alarm signal Sa is output from the terminal Aout. Thus, with the charge-discharge protection circuit 10 having this configuration, the secondary battery 3 may be safely charged or discharged in comparison to that with the related art technologies.

When the surface temperature of the secondary battery 3 is equal to or higher than the charge temperature upper limit Talmh or when the surface temperature of the secondary battery 3 is equal to or lower than the charge temperature lower limit Talml, a pulsed signal Sa is output from the terminal Aout regardless of levels of the voltages of the cells 3a and 3b. For example, when the surface temperature of the secondary battery 3 is within the high-temperature range, and at least one of the voltages of the cells 3a and 3b is equal to or higher than the overcharge alarm voltage Va2, but the surface temperature of the secondary battery 3 is then increased to be higher than the charge temperature upper limit Talmh, an alarm signal Sa is switched from a low-level signal to a pulse signal. Further, when the surface temperature of the secondary battery 3 is within the standard-temperature range, and at least one of the voltages of the cells 3a and 3b is equal to or higher than the overcharge alarm voltage Va3, but the surface temperature of the secondary battery 3 is then decreased to be lower than the charge temperature lower limit Talml, an alarm signal Sa is switched from a low-level signal to a pulse signal. In response to the pulsed signal Sa, the battery charger 2 stops charging of the secondary battery 3 and carries out processing such as outputting a signal reporting an abnormal temperature of the secondary battery 3 to an external device.

In the charge-discharge protection circuit 10 according to the first embodiment, since a high-level alarm signal Sa, a low-level alarm signal Sa, or a pulsed signal Sa is output based on the voltages of the cells 3a and 3b and the surface temperature of the secondary battery 3, the secondary battery 3 may be protected from an abnormal temperature or protected from being overcharged so that the secondary battery 3 is safely charged in comparison to that with the related art technologies.

### Second Embodiment

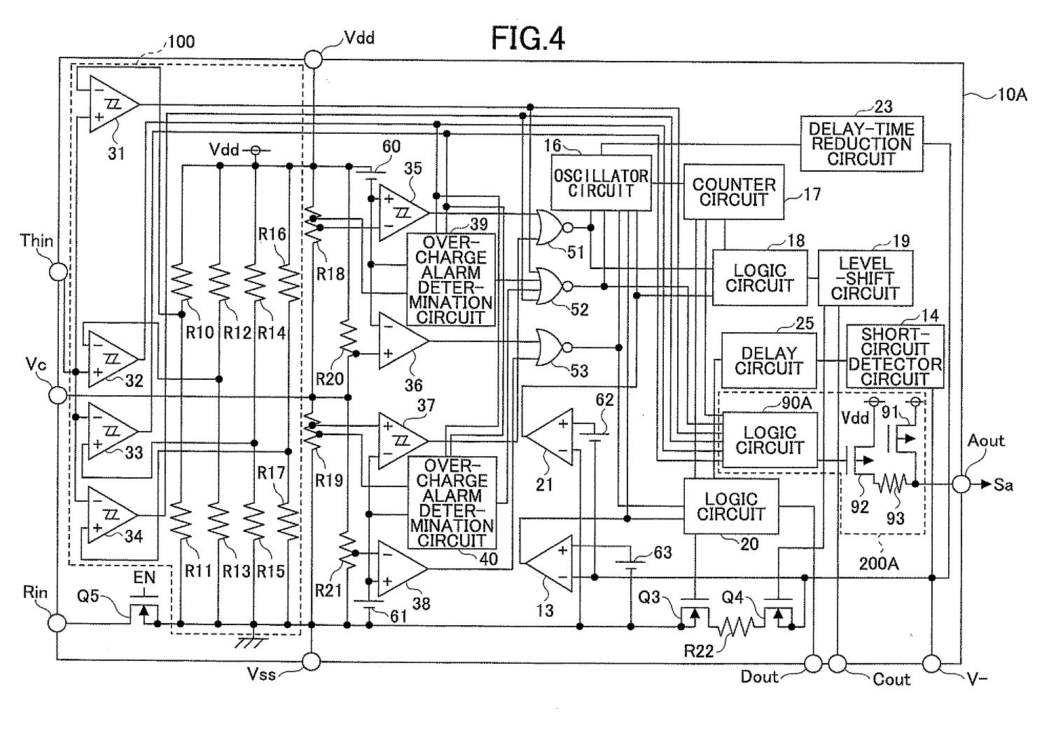

FIG. 4 is a circuit diagram of a charge-discharge protection circuit 10A according to a second embodiment. A charge-discharge protection circuit 10A according to the second embodiment includes an alarm signal generator circuit 200A in place of the alarm signal generator circuit 200 of the charge-discharge protection circuit 10 according to the first embodiment.

The alarm signal generator circuit 200A includes a logic circuit 90A, P-channel field-effect transistors 91 and 92, and a resistor 93. In the alarm signal generator circuit 200A, a drain of the P-channel MOS field-effect transistor 91 is connected to the terminal Aout, and a source of the P-channel MOS field-effect transistor 91 is connected to the terminal Vdd. Further, a drain of the P-channel MOS field-effect transistor 92 is connected via the resistor 93 to the terminal Aout, and a source of the P-channel MOS field-effect transistor 92 is connected to the terminal Vdd.

The logic circuit 90A outputs a low-level signal to a gate of the P-channel MOS field-effect transistor 91 and also outputs a high-level signal to a gate of the P-channel MOS field-effect transistor 92 when receiving a high-level signal output from the NOR gate 52. Accordingly, a high-level alarm signal Sa is output from the terminal Aout. Further, when receiving a low-level signal output from the NOR gate 52, the logic circuit 90A determines, based on the respective signals output from the comparators 31 through 34, (a) whether the surface temperature of the secondary battery 3 is equal to or lower than the charge temperature lower limit Talml, or whether the surface temperature of the secondary battery 3 is equal to higher than the charge temperature upper limit Talmh; or (b) whether the surface temperature of the secondary battery 3 is higher than the charge temperature lower limit Talml and lower than the charge temperature upper limit Talmh. When the surface temperature of the secondary battery 3 is equal to or lower than the charge temperature lower limit Talml, or when the surface temperature of the secondary battery 3 is equal to or higher than charge temperature upper limit Talmh, the logic circuit 90A outputs a high-level signal to the gate of the P-channel MOS field-effect transistor 91 and also outputs a low-level signal to the gate of the P-channel MOS field-effect transistor 92. Accordingly, a signal Sa having a midpoint potential is output from the terminal Aout. When the surface temperature of the secondary battery 3 is higher than the charge temperature lower limit Talml and lower than the charge temperature upper limit Talmh, the logic circuit 90A generates a high-level signal to output the generated high-level signal to the gates of the P-channel MOS field-effect transistors 91 and 92. Accordingly, a low-level signal alarm signal Sa is output from the terminal Aout.

Thus, the charge-discharge protection circuit 10A according to the second embodiment may obtain the effect similar to that obtained in the first embodiment.

In the first and second embodiments, the surface temperature of the secondary battery 3 is detected by the thermistor TH that is incorporated in the battery pack 1. However, the location of the thermistor TH may not be limited to the above location. The thermistor TH may be provided such that the thermistor TH is thermally coupled with the secondary battery 3. Further, the thermistor TH may be configured to detect the ambient temperature of the secondary battery 3.

In the charge-discharge protection circuit according to the first and second embodiments, the secondary battery 3 includes two cells 3a and 3b; however, the configuration of the secondary battery 3 is not limited to such a configuration. The secondary battery 3 may be composed of one cell or composed of three or more cells. Further, in the first and second embodiments, the cells 3a and 3b are lithium-ion secondary batteries; however, the cells 3a and 3b are not limited to the lithium-ion secondary batteries. The cells 3a and 3b may be secondary batteries including nickel hydrogen batteries, and nickel cadmium batteries.

As described in detail above, since the charge-discharge protection circuit for a secondary battery, the battery pack having the protection circuit, and the electronic device having the battery pack according to the first and second embodiments include an overcharge alarm determination unit configured to determine whether the detected temperature is equal to or higher than an upper limit of a standard-temperature range based on the detected signal, and to subsequently select a predetermined first overcharge alarm voltage when the detected temperature is lower than the upper limit of the standard-temperature range, or to subsequently select a predetermined second overcharge alarm voltage lower than the predetermined first overcharge alarm voltage when the detected temperature is equal to or higher than the upper limit of the standard-temperature range, so as to output a signal indicating whether or not a voltage of the secondary battery is equal to or higher than the selected one of the first overcharge alarm voltage and the second overcharge alarm voltage; and an alarm signal generator unit configured to generate, when the voltage of the secondary battery is equal to or higher than the selected one of the first overcharge alarm voltage and the second overcharge alarm voltage, an alarm signal based on the signal output from the overcharge alarm determination unit, the secondary battery is prevented from being overcharged at a temperature equal to or higher than an upper limit of a standard-temperature range of the secondary battery. Thus, with the protection circuit for the secondary battery, the battery pack having the protection circuit and the electronic device having the battery pack according to the first and second embodiments, the secondary battery may be charged safer than with the related art technologies.

The charge-discharge protection circuit for the secondary battery, the battery pack having the protection circuit, and the electronic device having the battery pack according to the first and second embodiments include an overcharge alarm determination unit configured to determine whether the detected temperature is equal to or higher than an upper limit of a standard-temperature range based on the detected signal, and to subsequently select a predetermined first overcharge alarm voltage when the detected temperature is lower than the upper limit of the standard-temperature range, or to subsequently select a predetermined second overcharge alarm voltage lower than the predetermined first overcharge alarm voltage when the detected temperature is equal to or higher than the upper limit of the standard-temperature range, so as to output a signal indicating whether or not a voltage of the secondary battery is equal to or higher than the selected one of the first overcharge alarm voltage and the second overcharge alarm voltage; and an alarm signal generator unit configured to generate, when the voltage of the secondary battery is equal to or higher than the selected one of the first overcharge alarm voltage and the second overcharge alarm voltage, an alarm signal based on the signal output from the overcharge alarm determination unit. With the protection circuit for the secondary battery, the battery pack having the protection circuit, and the electronic device having the battery pack according to the first and second embodiments, the secondary battery is prevented from being overcharged at a temperature equal to or higher than an upper limit of a standard-temperature range of the secondary battery, and the secondary battery may thus be charged safer than with the related art technologies.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

This patent application is based on Japanese Priority Patent Application No. 2009-208384 filed on Sep. 9, 2009, the entire contents of which are hereby incorporated herein by reference.

What is claimed is:

1. A protection circuit for protecting a secondary battery, comprising:
a temperature detector unit configured to detect a temperature of the secondary battery and to output a detected signal indicating the detected temperature;
an overcharge alarm determination unit configured to determine whether or not the detected temperature is equal to or higher than an upper limit of a standard-temperature range based on the detected signal, and to subsequently select a predetermined first overcharge alarm voltage when the detected temperature is lower than the upper limit of the standard-temperature range, or to subsequently select a predetermined second overcharge alarm voltage that is lower than the predetermined first overcharge alarm voltage when the detected temperature is equal to or higher than the upper limit of the standard-temperature range, so as to output a signal indicating whether or not a voltage of the secondary battery is equal to or higher than the selected one of the first overcharge alarm voltage and the second overcharge alarm voltage; and
an alarm signal generator unit configured to generate, when the voltage of the secondary battery is equal to or higher than the selected one of the first overcharge alarm voltage and the second overcharge alarm voltage, an alarm signal based on the signal output from the overcharge alarm determination unit.

2. The protection circuit as claimed in claim 1,
wherein the overcharge alarm determination unit is further configured to determine whether the detected temperature is equal to or lower than a lower limit of the standard-temperature range based on the detected signal, and to subsequently select the predetermined first overcharge alarm voltage when the detected temperature is higher than the lower limit of the standard-temperature range, or to subsequently select a predetermined third overcharge alarm voltage that is lower than the predetermined first overcharge alarm voltage when the detected temperature is equal to or lower than the lower limit of the standard-temperature range.

3. The protection circuit as claimed in claim 2,
wherein the alarm signal generator unit is further configured to determine, based on the detected signal, whether or not the detected temperature is equal to or higher than a predetermined upper limit of a charge temperature that is higher than the upper limit of the standard-temperature range or whether or not the detected temperature is equal to or lower than a predetermined lower limit of the charge temperature that is lower than the lower limit of the standard-temperature range, and to subsequently generate, when the detected temperature is equal to or higher than the predetermined upper limit of the charge temperature, or when the detected temperature is equal to or lower than the predetermined lower limit of the charge temperature, the alarm signal regardless of levels of the voltage of the secondary battery.

4. The protection circuit as claimed in claim 1, further comprising:
an overcharge detector unit configured to detect whether or not the voltage of the secondary battery is equal to or higher than a predetermined overcharge detection voltage;
an charge overcurrent detector unit configured to detect whether or not a charge current of the secondary battery is equal to or higher than a predetermined first current value;
a first signal generator unit configured to generate a first control signal for controlling cutting off of a charging path of the secondary battery when at least one of a first condition in which the voltage of the secondary battery is equal to or higher than the predetermined overcharge detection voltage and a second condition in which the charge current of the secondary battery is equal to or higher than the predetermined first current value is satisfied;
an overdischarge detector unit configured to detect whether or not the voltage of the secondary battery is equal to or lower than a predetermined overdischarge detection voltage;
a discharge overcurrent detector unit configured to detect whether or not a discharge current of the secondary battery is equal to or higher than a predetermined second current value; and
a second signal generator unit configured to generate a second control signal for controlling cutting off of a discharging path of the secondary battery when at least one of a third condition in which the voltage of the secondary battery is equal to or lower than the predetermined overdischarge detection voltage and a fourth condition in which the discharge current of the secondary battery is equal to or higher than the predetermined second current value is satisfied.

5. The protection circuit as claimed in claim 3,
wherein the alarm signal generator unit generates a predetermined first level alarm signal when the detected temperature is higher than the predetermined lower limit of the charge temperature and lower than the predetermined upper limit of the charge temperature, and the voltage of the secondary battery is equal to or higher than the selected one of the first overcharge alarm voltage and the second overcharge alarm voltage,
wherein the alarm signal generator unit generates a predetermined second level alarm signal when the detected temperature is higher than the predetermined lower limit of the charge temperature and lower than the predetermined upper limit of the charge temperature, and the voltage of the secondary battery is lower than the selected one of the first overcharge alarm voltage and the second overcharge alarm voltage, and
wherein the alarm signal generator unit generates a pulsed alarm signal regardless of levels of the voltage of the secondary battery when the detected temperature is equal to or higher than the predetermined upper limit of the charge temperature, or when the detected temperature is equal to or lower than the predetermined lower limit of the charge temperature.

6. The protection circuit as claimed in claim 3,
wherein the alarm signal generator unit generates a predetermined first level alarm signal when the detected temperature is higher than the predetermined lower limit of the charge temperature and lower than the predetermined upper limit of the charge temperature, and the voltage of the secondary battery is equal to or higher than the selected one of the first overcharge alarm voltage and the second overcharge alarm voltage,
wherein the alarm signal generator unit generates a predetermined second level alarm signal when the detected temperature is higher than the predetermined lower limit of the charge temperature and lower than the predetermined upper limit of the charge temperature, and the voltage of the secondary battery is lower than the selected one of the first overcharge alarm voltage and the second overcharge alarm voltage, and
wherein the alarm signal generator unit generates a predetermined third level alarm signal regardless of levels of the voltage of the secondary battery when the detected temperature is equal to or higher than the predetermined upper limit of the charge temperature, or when the detected temperature is equal to or lower than the predetermined lower limit of the charge temperature.

7. A battery pack comprising:
a secondary battery; and
the protection circuit as claimed in claim 1.

8. An electronic devices comprising the battery pack as claimed in claim 7.
